(19) United States
(12) Patent Application Publication
(10) Pub. No.: US 2003/0010076 A1
(43) Pub. Date: Jan. 16, 2003

(54) Specific addition and/or incorporation of volcanic ash as an ingredient in a commercially available plant potting soil or plant potting mix

(76) Inventor: Michael Anthony Stewart, Salem, OR (US)

Correspondence Address: Michael A. Stewart, 1755 Cottage St. S.E., Salem, OR, 97302, US

(21) Appl. No.: 09/928,879

(22) Filed: Aug. 14, 2001

Related U.S. Application Data
(60) Provisional application No. 60/228,775, filed on Aug. 29, 2000.

(51) Int. Cl. C05D 1/00

(52) U.S. Cl. 71/62

(57) ABSTRACT

Prior to this invention, no commercially available plant potting soil or plant potting mix specifically incorporated material commonly known as volcanic ash as an ingredient. My invention is the specific incorporation of volcanic ash as an ingredient in a commercially available plant potting soil or plant potting mix and the labeling of the volcanic ash ingredient on the product label.

### CROSS REFERENCE

Provisional Patent Application No. 60/228,775

### STATEMENT REGARDING FEDERALLY SPONSORED RESEARCH OR DEVELOPMENT

This patent application does not make use of any federally sponsored research or development.

### BACKGROUND OF THE INVENTION

This invention occurred in March of 1999.

Michael A. Stewart is President of Sand Products Company, Inc. in Portland, Oreg. Sand Products Company has been involved in the processing of Mt. St. Helens volcanic sand and ash for industrial uses since 1997.

In a diversification toward manufacture of a potting soil product, Michael A. Stewart recalled that, following the eruption of Mt. St. Helens in 1980, many people reported that, with the resultant dusting of volcanic ash upon their planting soil, flowers and gardens responded with the best growth they had ever seen.

Michael A. Stewart was also aware that soil in many areas of the world in the vicinity of past volcanic activity is often referred to as “fertile, volcanic soil”.

Michael A. Stewart researched and determined that no currently available commercial potting soils or mixtures contained, or purported to contain, volcanic ash.

With this in mind, Michael A. Stewart formulated a potting soil product—Ultra-Gro Premium Potting Soil—which contained approximately 3% volcanic ash and clearly listed this ingredient on the label of the bag. This product has been available commercially since January of 2001 and, to date, some 3500 20 Qt. bags have been either sold or distributed free of charge to interested customers.

This patent is applied for under the basic language of the patent statute which states that any person who “invents or discovers any new and useful . . . composition of matter . . . may obtain a patent.” Composition of matter herein refers to the composition of commercially available plant potting soils and plant potting mixes available at the time of the invention. The new and useful composition is the addition of volcanic ash as an ingredient of any commercially available plant potting soil and/or plant potting mix.

Volcanic ash, from lab report (copy attached) contains micro-nutrients and other properties, including pH, which enhance plant growth.

The best classification for this patent may be Class 504—Plant Protecting and Regulating Compositions—although there may be other and/or more appropriate classes.

With regards to Class 504, Michael A Stewart would like to patent a treatment of habitat, specifically commercially available plant potting soils and plant potting mixtures for living, terrestrial plants by the incorporation of volcanic ash as an ingredient of the plant potting soil or plant potting mix. This process does not involve more than the mere incorporation of volcanic ash in the habitat.

### BRIEF SUMMARY OF THE INVENTION

This invention is the simple, specific addition of any quantity of very fine, granular material commonly known as volcanic ash to the composition of any commercially available plant potting soil or plant potting mix product.

The invention solves the previously existing problem of there being no commercially available plant potting soil or potting mix available incorporating volcanic ash in the product and/or listing volcanic ash as an ingredient on the label of the product.

### BRIEF DESCRIPTION OF SEVERAL VIEWS OF THE DRAWING

Not applicable. There are no drawings in this patent application.

### DETAILED DESCRIPTION OF THE INVENTION

This invention is the specific addition and/or incorporation of any amount of material commonly referred to as volcanic ash into the composition of any commercially available plant potting soils or plant potting mixes.

Volcanic ash is defined as very fine, granular, sandy material that has erupted from a volcano and is commonly referred to as volcanic ash. Normally, this material is gray in color but may be of any color as long as the material in question is commonly referred to as volcanic ash.

This invention makes commercially available a volcanic ash added plant potting soil or plant potting mix where, previous to the invention, none had been available.

The invention is to specifically add or blend volcanic ash in any amount in the formulation of a commercially available plant potting soil or plant potting mix. The goal of the patent is to distinguish the volcanic ash added plant potting soil or plant potting mix from any other. The goal of the patent is also to make available the benefits, such as they are, or may be, or are thought to be, of the addition of the volcanic ash to a commercially available plant potting soil or plant potting mix.

1. What I claim as my invention is the intentional and specific addition and/or incorporation of volcanic ash as an ingredient in a commercially available plant potting soil or plant potting mix.

2. What I claim as my invention is the listing of volcanic ash as an ingredient on the packaging of a commercially available plant potting soil or plant potting mix.
